(19) United States
(12) Patent Application Publication
(10) Pub. No.: US 2014/0032367 A1
(43) Pub. Date: Jan. 30, 2014

(54) SYSTEM AND METHOD OF PROVIDING RECOMMENDED ARTICLE CORRESPONDING TO USER'S CRITERIA

(71) Applicant: Aidan Joungil CHO, Austin, TX (US)

(72) Inventor: Aidan Joungil CHO, Austin, TX (US)

(21) Appl. No.: 13/950,602

(22) Filed: Jul. 25, 2013

(30) Foreign Application Priority Data
Jul. 25, 2012 (KR) 10-2012-0081396

(51) Int. Cl. G06Q 30/06

(52) U.S. Cl. CPC G06Q 30/0627
USPC 705/26.63

(57) ABSTRACT

Provided are a system and method of providing a recommended article corresponding to a user's criteria. The system includes a recommender information storing unit that stores information of recommenders recommending articles; a recommended article registering unit where the articles recommended by the recommenders are registered; a recommendation criteria storing unit that receives recommendation criteria from users wanting to receive recommended articles, the recommendation criteria including recommender selection criteria for recommenders from whom the users want to receive the recommended articles; a recommended article extracting unit that extracts articles recommended by the recommender corresponding to the recommender selection criteria, as the recommended articles, according to criteria registered in the recommendation criteria storing unit; and a recommended article providing unit that provides the extracted recommended articles to the users.

### CROSS-REFERENCE TO RELATED PATENT APPLICATION

This application claims the benefit of Korean Patent Application No. 10-2012-0081396, filed on Jul. 25, 2012, in the Korean Intellectual Property Office, the disclosure of which is incorporated herein in its entirety by reference.

### BACKGROUND OF THE INVENTION

1. Field of the Invention

The present invention relates to a system and method of providing a recommended article, and more particularly, to a system and method of providing a recommended article, in which a user receiving a recommended article is allowed to select recommended article selection criteria, and more specifically, a recommender's criteria used for selecting a recommended article.

2. Description of the Related Art

In the past, news articles have been provided to the public through traditional newspapers, TV, radio news programs, and the like.

In recent years, however, news articles have been provided through more diverse media. A representative method of providing an article is the Internet.

In the case of the Internet, news articles are provided through more diverse media, such as various portal sites, as well as on sites of newspaper companies.

Since news articles are provided through the Internet, news may be provided through more diverse media in real time.

However, since users receive too many articles, the users become confused about the priority of the articles or the range to read the article.

In order to solve such limitations, an editor of a portal site or a newspaper company selects an article to be displayed on a main screen, and primarily provides users with only a predetermined range of the selected article. In addition, users may select articles by referring to the introduction of the most read article, the most commented article, and the like.

Moreover, methods as disclosed in Korean Patent Application Publication No. 2010-78675 have been studied which makes a recommender group, receives recommendation on articles, and exposes the recommended articles to a best article page.

In the case of a method of selecting an article by recommendation from an editor or recommenders, recommended articles are selected according to the editor or recommenders' taste. However, when the taste of the user who actually reads the articles is different from the taste of the editor or recommenders who select the articles, only articles that are useless to the user may be recommended.

The method of recommending articles having many hits and comments may not be a fair method of recommending article in that when articles are first ranked, their hits or comments will be increased.

Persons may wonder what articles are recommended by persons of similar age groups to them, what articles are read by many persons whose major is similar to them, or what articles are determined as valuable.

### CITATION LISTS

### Patent Literature

Patent Literature 1: Korean Patent Application Publication NO. 2010-78675 (published on Jul. 8, 2010) (ARTICLE EDITING METHOD AND ARTICLE PROVIDING SYSTEM), SUMMARY, CLAIM 1

### SUMMARY OF THE INVENTION

The present invention provides a system and method of providing a recommended article according to a users criteria.

According to an aspect of the present invention, there is provided a system for providing a recommended article, the system including: a recommender information storing unit that stores information of recommenders recommending articles; a recommended article registering unit where the articles recommended by the recommenders are registered; a recommendation criteria storing unit that receives recommendation criteria from users wanting to receive recommended articles, the recommendation criteria including recommender selection criteria for recommenders from whom the users want to receive the recommended articles; a recommended article extracting unit that extracts articles recommended by the recommender corresponding to the recommender selection criteria, as the recommended articles, according to criteria registered in the recommendation criteria storing unit; and a recommended article providing unit that provides the extracted recommended articles to the users.

According to another aspect of the present invention, there is provided a method of providing a recommended article, the method including: storing information of recommenders recommending articles; registering the articles recommended by the recommenders; receiving recommendation criteria from users wanting to receive recommended articles, the recommendation criteria including recommender selection criteria for recommenders from whom the users want to receive the recommended articles; extracting articles recommended by the recommender corresponding to the recommender selection criteria, as the recommended articles, according to the registered criteria; and providing the extracted recommended articles to the users.

The recommendation criteria may further include criteria related to a feature of the article, and the recommended article extracting unit may extract an article corresponding to the criteria related to the feature of the article, as the recommended article, among the recommended articles recommended by the recommenders corresponding to the recommender selection criteria.

The article recommended by the recommender may be an article recommended by the recommenders.

The article recommended by the recommender may be an article posted on a site accessed by the recommenders.

The recommendation criteria may be provided by combination of a plurality of criteria.

The system may further include a calculating unit that pays a charge for provision of the recommended article.

According to another aspect of the present invention, there is provided a computer-readable medium storing a program for implementing the above-described method.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram illustrating a configuration of a system for providing a recommended article, according to an embodiment of the present invention; and

FIG. 2 is a flowchart illustrating a method of providing a recommended article, according to an embodiment of the present invention.

### DETAILED DESCRIPTION OF THE INVENTION

Hereinafter, exemplary embodiments of the present invention will be described in detail with reference to the accompanying drawings.

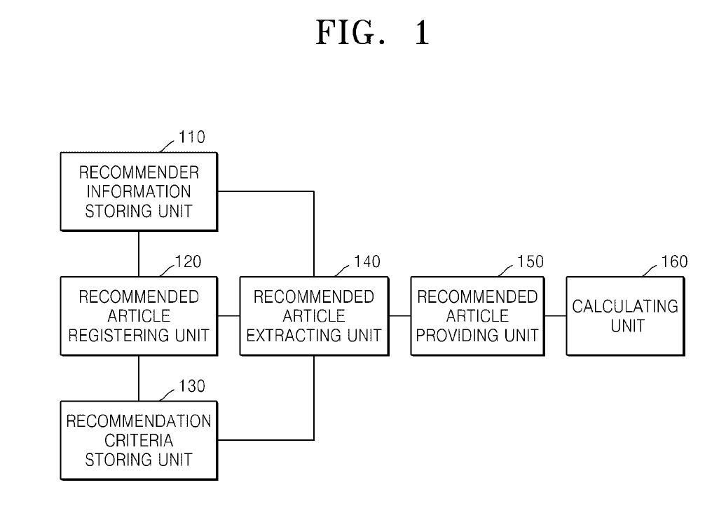

FIG. 1 is a block diagram illustrating a configuration of a system for providing a recommended article, according to an embodiment of the present invention.

The system according to the embodiment of the present invention includes a recommender information storing unit 110, a recommended article registering unit 120, a recommendation criteria storing unit 130, a recommended article extracting unit 140, a recommended article providing unit 150, and a calculating unit 160.

The recommender information storing unit 110 stores information of persons selected as recommenders.

An operator of the system according to the embodiment of the present invention selects recommenders by pre-applications, or previously selects recommenders.

When selected as recommenders, each of the recommenders submits his or her information, and the submitted information is stored in the recommender information storing unit 110.

The information stored in the recommender information storing unit 110 may change according to the type of the recommended article selection criteria permitted in the system.

For example, if the recommended article selection criteria is set to select only the major of the article recommender, only the major of each recommender may be stored in the recommender information storing unit 110.

If the recommender's age, residence, language, and company can be included in the recommendation criteria, information thereof may also be stored in the recommender information storing unit 110.

The recommender information may be stored in the recommender information storing unit 110 in such a manner that recommenders directly access the system and input each item. Alternatively, the recommender information may be stored in the recommender information storing unit 110 in such a manner that a system operator individually receives information of recommenders and directly inputs the received information.

In addition to information regarding the recommendation criteria, information for compensation may also be stored in the recommender information storing unit 110.

According to the service type, when a recommended article is read, predetermined compensation or benefits, such as cash or points, may be given to the recommender who recommends the relevant article. In this case, compensation information for compensation or benefit may also be stored in the recommender information storing unit 110.

Recommended articles generated by the recommenders registered in the recommender information storing unit 110 are registered in the recommended article registering unit 120.

The recommended articles may be registered in such a manner that the recommenders directly access the system and input the recommended articles.

When the recommenders input the recommended articles, only a predetermined number of articles may be recommended per unit time. If the number of recommendable articles is not limited, the basic feature of the recommendation system may not be well reflected by excessively indiscriminate recommendation.

The recommenders may be requested to access the system of the embodiment and input recommended articles every unit time. For example, an article input time of six hours once a day may be provided to the recommenders.

When the articles are input, only a URL of a news page in which the article is put may be input. Alternatively, address information of a news page, a news headline, an article summary, star-point evaluation, and ranking of their own recommended articles may also be input.

In addition, the reason for selecting the recommended article may be input. If the input of the reason for recommendation is required, it is possible to prevent the recommenders from recommending any article in order to fill a quota. Hence, when recommenders are reselected, it may be determined whether the recommenders fulfill their responsibility earnestly.

Another method of registering recommended articles is to count sites accessed by each recommender and register articles of the most accessed sites as recommended articles.

In this case, information of sites accessed by the recommenders may be gathered by getting the recommenders' consent and installing a program for notifying the accessed sites on the recommenders' computer. When the recommenders log in to sites linked to a particular media site and read articles, information of articles the recommenders search in the media site may be gathered.

At this time, the articles searched by each recommender may be registered in the recommended article registering unit 120. Even in this case, time may be set, and only articles searched by the recommenders within the set time may be registered in the recommended article registering unit 120.

The recommendation criteria storing unit 130 is accessed by users, receives criteria for article recommendation, and stores the criteria of the user.

The criteria for article recommendation may be freely set within a predetermined range that is set by a system operator.

The recommendation criteria includes recommender selection criteria by default. That is, the recommendation criteria includes criteria directly associated with the recommender, such as the recommender's major, age, sex, interests, residence, nationality, first language, post-secondary education, education, and field of work.

In addition, the recommendation criteria may include criteria associated with the feature of the article, such as a news media site to be recommended, the section of the article the recommender wants to receive, and the language of the desired recommended article.

As described in the above example, the articles may be recommended by simply selecting the major of the recommenders. For example, articles that are much recommended by persons majoring in electronics may be provided as recommended articles.

Articles may also be recommended by combining a plurality of criteria. For example, like “articles recommended by A university students majoring in electronics among articles belonging to a politics section of a B newspaper company”, a plurality of recommendation criteria may be set in combination.

In addition, time criteria for selecting recommended articles may be included in the recommendation criteria storing unit 130.

For example, time criteria for selecting recommended articles, such as “articles recommended within twenty-four hours” or “articles posted within twenty-four hours”, may be set.

In addition, the number of articles recommended in one time for each user may be set in the recommendation criteria storing unit 130. When the user does not set this, articles whose number is set by the system operator may be recommended.

The recommended article extracting unit 140 extracts articles corresponding to the recommendation criteria stored in the recommendation criteria storing unit 130 among the articles registered in the recommended article registering unit 120.

The method of extracting the recommended articles may be implemented such that a predetermined number of articles are recommended based on the number of recommendations or hits, or may be implemented such that ranking or star points determined by the recommenders are weighted and articles corresponding to the recommendation criteria are recommended using total scores.

The recommended article providing unit 150 provides users with recommended articles extracted by the recommended article extracting unit 140.

As for the method of providing the recommended articles, when a user visits a site operated by the system of the embodiment and logs in, a separate page for providing recommended articles may be provided such that the user can view the recommended articles. The articles may be provided to the user via e-mail, text messages, push messages, or the like.

When the recommended article is provided, the whole article may be provided, but link information of the relevant article and a headline for understanding the content of the article, part of content, or summary of the article may be provided. In this case, the user may access the relevant site using the link information and view the relevant article.

In this manner, it is possible to avoid a copyright dispute and cause traffic in a media site providing the relevant article.

When lots of traffic is caused in the media site, the attraction and management of advertisement or the like are favorably influenced. Therefore, providing the recommended articles in the above manner will be useful for the media site.

Specifically, when the system according to the embodiment of the present invention is linked with a particular media site and provides only articles of the particular media site as recommended articles, compensation for causing traffic may be obtained from the media site, ensuring one more profit source.

When providing the recommended article, the recommended article providing unit 150 may also provide information about the reason for recommendation recorded by the recommender.

When the user does not like the recommended article, the user may provide feedback on the recommended article or may provide feedback on the recommender who unfaithfully records the reason for recommendation. When negative feedback is provided on the recommended article, penalty points or other negative influence may be given to all recommenders recommending the relevant article. When negative feedback is given on the reason for recommendation, penalty points or the like may be given to only the recommender that wrote the reason for recommendation.

The recommenders having high penalty points may suffer the disadvantage of not being selected as recommender in future, and only faithful recommenders may be allowed to continuously recommend articles.

The calculating unit 160 performs a calculation according to the provision of recommended articles.

The calculation as used herein includes a calculation for users who subscribed to recommended articles, and a calculation for recommenders.

The calculation for users who subscribed to recommended articles charges for provision of recommended articles when the service according to the embodiment of the present invention is a charged service.

The charge may be a flat rate in each term, or may be made for each recommended article whenever the user selects the recommended article.

In the case of making a charge for each recommended article, a specific sum of money is prepaid and some money is withdrawn from the prepaid money whenever the recommended article is searched.

The calculation for the recommender is to save cash or points as compensation for recommendation.

In the case of saving points, points may be saved according to the number of articles recommended by the recommender, and points may be saved whenever the article recommended by the recommender is searched by users.

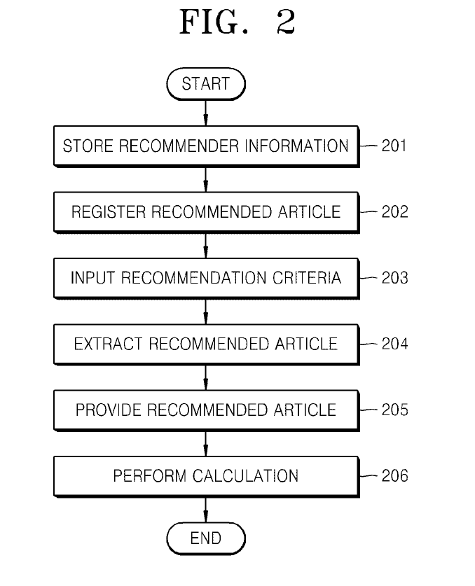

FIG. 2 is a flowchart illustrating a method of providing a recommended article, according to an embodiment of the present invention.

All operations of the method according to the embodiment of the present invention are performed by a computer processor.

First, the recommender information storing unit 110 stores information of persons selected as recommenders (201).

The recommender information may change according to the type of the recommended article selection criteria permitted in the system. As described above, the recommender information may include the recommender's major, age, sex, interests, residence, nationality, first language, post-secondary education, education, and field of work.

In addition to information regarding the recommendation criteria, information for compensation may also be stored in the recommender information storing unit 110.

Recommended articles generated by the recommenders registered in the recommender information storing unit 110 are registered in the recommended article registering unit 120 (202).

As described above, the recommended articles may be registered in such a manner that the recommenders directly access the system and input the recommended articles. Alternatively, the recommended articles may be registered in such a manner that sites accessed by the respective recommenders are gathered and articles of the relevant sites are registered as recommended articles.

As described above, in the case of the method in which the recommenders directly access the system and input their recommended articles, only a predetermined number of articles may be recommended per unit time. When the articles are input, only a URL of a news page in which the article is put may be input. Alternatively, address information of a news page, a news headline, an article summary, star-point evaluation, ranking of their own recommended articles, and the reason for selecting the recommended article may also be input.

As described above, in the case of the method of gathering the sites accessed by the respective recommenders and registering the articles of the relevant sites as the recommended articles, information of sites accessed by the recommenders may be gathered by getting the recommenders' consent and installing a program for indicting the accessed sites on the recommenders' computer. When the recommenders log in to sites linked to a particular media site and read articles, information of articles the recommenders search in the media site may be gathered

In addition, as described above, in this case, only articles searched by the recommenders within a predetermined time may be registered in the recommended article registering unit 120.

The recommendation criteria storing unit 130 is accessed by users, receives criteria for article recommendation, and stores the criteria of the user (203).

As described above, the criteria for article recommendation may be freely set within a predetermined range that is set by a system operator. The recommendation criteria includes criteria directly associated with the recommender, such as the recommender's major, age, sex, interests, residence, nationality, first language, post-secondary education, education, and field of work, and criteria associated with the feature of the article, such as a news media site to be recommended, the section of the article the recommender wants to receive, and the language of the desired recommended article.

In addition, as described above, the user may set time criteria for selecting recommended articles, and may set the number of articles recommended in one time.

The recommended article extracting unit 140 extracts articles corresponding to the recommendation criteria stored in the recommendation criteria storing unit 130 among the articles registered in the recommended article registering unit 120 (204).

As described above, the method of extracting the recommended articles may be implemented such that a predetermined number of articles are recommended based on the number of recommendations or hits, or may be implemented such that ranking or star points determined by the recommenders are weighted and articles corresponding to the recommendation criteria are recommended using total scores.

The recommended article providing unit 150 provides users with recommended articles extracted by the recommended article extracting unit 140 (205).

As for the method of providing the recommended articles, when a user visits a site operated by the system of the embodiment and logs in, a separate page for providing recommended articles may be provided such that the user can view the recommended articles. The articles may be provided to the user via e-mail, text messages, push messages, or the like. When the recommended article is provided, the whole article may be provided, but link information of the relevant article and a headline for understanding the content of the article, part of content, or summary of the article may be provided. In this case, the user may access the relevant site using the link information and view the relevant article.

When providing the recommended article, information about the reason for recommendation recorded by the recommender may also be provided. When the user does not like the recommended article, the user may provide negative feedback on the recommended article or the reason for recommendation.

In addition, when the negative feedback is provided to the recommended article, penalty points or other negative influence may be given to all recommenders recommending the relevant article. When the negative feedback is given on the reason for recommendation, penalty points or the like may be given to only the recommender that wrote the reason for recommendation.

The calculating unit 160 performs a calculation according to the provision of recommended articles (206).

The calculation as used herein may include a calculation for users who subscribed to recommended articles, and a calculation for recommenders.

As described above, the charging may be a flat rate in each term, or may be made for each recommended article searched by the users.

The calculation for the recommender is to save cash or points as compensation for recommendation. Points or the like may be saved according to the number of recommended articles, and points or the like may be saved whenever the article recommended by the recommender is searched by users.

For convenience, it is illustrated in FIG. 2 as if the user inputs the recommendation criteria and extracts the recommended article after the recommender recommends articles, but the process of recommending articles by the recommender, the process of inputting the recommendation criteria by the user, and the like are performed in parallel. That is, there is no time-series relationship between these processes.

According to the embodiments of the present invention, articles selected by recommenders corresponding to a user's criteria are recommended to the user. Therefore, the user may receive recommended articles that are consistent with the users taste, purpose, and the like.

In addition, in view of the media sites providing the articles, recommenders continuously browse news, and users also browse the recommended articles, leading to an increase in hits of the articles.

A computer-readable code can be recorded/transferred on a medium in a variety of ways, with examples of the medium including recording media, such as magnetic storage media (e.g., ROM, floppy disks, hard disks, etc.) and optical recording media (e.g., CD-ROMs or DVDs), and transmission media such as Internet transmission media. The media may also be a distributed network, so that the computer-readable code is stored/transferred and executed in a distributed fashion. Furthermore, the processing element could include a processor or a computer processor, and processing elements may be distributed and/or included in a single device.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A system for providing a recommended article, the system comprising:
a recommender information storing unit that stores information of recommenders recommending articles;
a recommended article registering unit where the articles recommended by the recommenders are registered;
a recommendation criteria storing unit that receives recommendation criteria from users wanting to receive recommended articles, the recommendation criteria including recommender selection criteria for recommenders from whom the users want to receive the recommended articles;
a recommended article extracting unit that extracts articles recommended by the recommender corresponding to the recommender selection criteria, as the recommended articles, according to criteria registered in the recommendation criteria storing unit; and
a recommended article providing unit that provides the extracted recommended articles to the users.

2. The system of claim 1, wherein the recommendation criteria further comprises criteria related to a feature of the article, and the recommended article extracting unit extracts an article corresponding to the criteria related to the feature of the article, as the recommended article, among the recommended articles recommended by the recommenders corresponding to the recommender selection criteria.

3. The system of claim 1, wherein the article recommended by the recommender is an article recommended by the recommenders.

4. The system of claim 1, wherein the article recommended by the recommender is an article posted on a site accessed by the recommenders.

5. The system of claim 1, wherein the recommendation criteria is provided by combination of a plurality of criteria.

6. The system of claim 1, further comprising a calculating unit that pays a charge for provision of the recommended article.

7. A method of providing a recommended article, the method comprising:
storing information of recommenders recommending articles;
registering the articles recommended by the recommenders;
receiving recommendation criteria from users wanting to receive recommended articles, the recommendation criteria including recommender selection criteria for recommenders from whom the users want to receive the recommended articles;
extracting articles recommended by the recommender corresponding to the recommender selection criteria, as the recommended articles, according to the registered criteria; and
providing the extracted recommended articles to the users.

8. The method of claim 7, wherein the recommendation criteria further comprises criteria related to a feature of the article, and the extracting of the recommended articles comprises extracting an article corresponding to the criteria related to the feature of the article, as the recommended article, among the recommended articles recommended by the recommenders corresponding to the recommender selection criteria.

9. The method of claim 7, wherein the article recommended by the recommender is an article recommended by the recommenders.

10. The method of claim 7, wherein the article recommended by the recommender is an article posted on a site accessed by the recommenders.

11. The method of claim 7, wherein the recommendation criteria is provided by combination of a plurality of criteria.

12. The method of claim 7, further comprising paying a charge for provision of the recommended article.

13. A computer-readable medium storing a program causing a computer processor to perform a method of providing a recommended article, the method comprising:
storing information of recommenders recommending articles;
registering the articles recommended by the recommenders;
receiving recommendation criteria from users wanting to receive recommended articles, the recommendation criteria including recommender selection criteria for recommenders from whom the users want to receive the recommended articles;
extracting articles recommended by the recommender corresponding to the recommender selection criteria, as the recommended articles, according to the registered criteria; and
providing the extracted recommended articles to the users.
